(19) United States
(12) Patent Application Publication
(10) Pub. No.: US 2026/0143033 A1
(43) Pub. Date: May 21, 2026

(54) DISTRIBUTED SEMANTIC PROCESSING OF SENSOR DATA

(71) Applicant: HUAWEI TECHNOLOGIES CO., LTD., Shenzhen (CN)

(72) Inventors: Abdellatif ZAIDI, Boulogne Billancourt (FR); Piotr Krasnowski, Boulogne Billancourt (FR)

(21) Appl. No.: 19/450,819

(22) Filed: Jan. 16, 2026

Related U.S. Application Data
(63) Continuation of application No. PCT/EP2023/069920, filed on Jul. 18, 2023.

(51) Int. Cl. H04L 67/12; G06N 3/0455; G06V 10/40; G06V 10/774; G06V 10/80; G06V 10/82; G06V 10/94

(52) U.S. Cl. CPC H04L 67/12; G06N 3/0455; G06V 10/40; G06V 10/774; G06V 10/80; G06V 10/82; G06V 10/95

(57) ABSTRACT

A sensor device arrangement comprises a sensor component, a semantic feature extraction, SFE, encoding component, a joint inference-source-channel, JISC, encoding component, and a transceiver component. The sensor component (11) is configured to generate the sensor data (Xₖ) of a target variable (Y), wherein the sensor data (Xₖ) comprises one or more features (Ũₖ). The SFE component (12) is configured to infer a semantically processed feature vector (Ũₖ) from the sensor data (Xₖ). The JISC encoding component (13) is configured to infer a JISC-encoded feature vector (Uₖ) from the inferred semantically processed feature vector (Ũₖ) in accordance with a channel model of an uplink channel of the wireless sensor network. The transceiver component (14) is configured to transmit, to a sensor fusion device (2) for distributed semantic processing of accumulated sensor data in the wireless sensor network, the inferred JISC-encoded feature vector (Uₖ) via the uplink channel.

### CROSS-REFERENCE TO RELATED APPLICATIONS

This application is a continuation of International Application No. PCT/EP2023/069920, filed on Jul. 18, 2023, the disclosure of which is hereby incorporated by reference in its entirety.

### TECHNICAL FIELD

The present disclosure relates generally to the field of semantic in-network learning, and particularly to a sensor device arrangement and a sensor fusion device for distributed semantic processing of (accumulated) sensor data, to methods of operating the same, and to a wireless sensor network.

### BACKGROUND ART

An increasing number of applications and services, such as robotics, autonomous driving, traffic management, and smart factory, rely on techniques such as object recognition and computer vision. In these applications and services, multiple distributed sensors gather information about the environment in order to enable some complex decision-making at a control center. However, due to the growing amount and/or complexity of sensor data to be transmitted by the sensors and processed by the control center, efficient decision-making becomes a very challenging task.

Another challenge related to wireless sensor networks is formed by fluctuating channel characteristics. Conventional communication systems rely on a separation principle in which source and channel coding are performed independently in two steps. Such systems tend to break down completely when the channel quality falls under a certain threshold, and the channel code is no longer capable of correcting the errors. This phenomenon is often referred to as the cliff effect. Furthermore, the two-step processing introduces unnecessary computational delays which are undesired in many real-time applications. It is thus generally no longer optimal to regard the source and channel coders separately.

### SUMMARY

It is an object to overcome the above-mentioned and other drawbacks by deep neural network (DNN) based semantic processing of sensor data and joint source-channel coding (JSCC).

The foregoing and other objects are achieved by the features of the independent claims. Further implementation forms are apparent from the dependent claims, the description and the figures.

According to a first aspect, a sensor device arrangement is provided for distributed semantic processing of sensor data in a wireless sensor network. The sensor device arrangement comprises a sensor component, a semantic feature extraction, SFE, encoding component, a joint inference-source-channel, JISC, encoding component, and a transceiver component. The sensor component is configured to generate the sensor data of a target variable, wherein the sensor data comprises one or more features. The SFE component is configured to infer a semantically processed feature vector from the sensor data. The JISC encoding component is configured to infer a JISC-encoded feature vector from the inferred semantically processed feature vector in accordance with a channel model of an uplink channel of the wireless sensor network. The transceiver component is configured to transmit, to a sensor fusion device for distributed semantic processing of accumulated sensor data in the wireless sensor network, the inferred JISC-encoded feature vector via the uplink channel.

The sensor device arrangement combines the benefits of semantic data processing, joint source channel coding, and distributed NN-based inference:

Semantic data processing focuses on the semantic features/interpretations of the sensor data, which may significantly reduce communication costs and latency, and improve resilience against channel distortions.

Joint source channel coding may avoid unnecessary computational delays and the cliff effect of conventional systems which tend to break down completely when the channel quality falls under a certain threshold and the channel code is no longer capable of correcting the errors, thereby improving the robustness to fluctuating channels.

Distributed NN-based inference involves that the disparate sensor devices process the input data by jointly considering the relevance of the data with respect to the goal and the relevance of the data obtained by other edge devices. The resulting encodings contain only semantically meaningful information and are—in connection with joint source channel coding—adapted to transmission over the wireless channel. At the receiving side, the received encodings distorted by the channel are used to directly infer the variable of interest, in contrast to the usual source reconstruction. This may massively reduce the amount of data to transmit and decrease the computational delay.

As used herein, a sensor device arrangement may refer to a composite sensor device whose components may be arranged to one another in various ways. For example, all components may be arranged together (co-located), or one or more components may be arranged separately from the remaining components.

As used herein, semantic processing may refer to processing of data on a semantic level, by focusing on its intended meaning (i.e., semantic features) rather than on its exact representation.

As used herein, semantic feature extraction (SFE) encoding may refer to inference of a feature vector (i.e., the one or more features) from the sensor data.

As used herein, joint inference-source-channel (JISC) encoding may refer to a combination of distributed inference (of locally observed data samples in accordance with a relevance for the given task), distributed source encoding (of locally observed data samples and implicitly of data samples observed by further sensor devices) and channel encoding (i.e., adaptation to the wireless channel).

As used herein, a transceiver may refer to a combination of a transmitter and a receiver for wireless communication.

As used herein, an inference may refer to a forward operation of a trained neural network.

As used herein, a vector may refer to an n-tuple (i.e., a finite sequence of n numbers) representing an element of a vector space.

As used herein, a channel model may refer to a mathematical representation of the detrimental effects of a communication channel on signals propagating through the same.

As used herein, an uplink channel may refer to a communication channel from any one of the disparate sources of the wireless sensor network (i.e., the respective sensor device arrangement) towards the central entity of the wireless sensor network (i.e., the sensor fusion device).

As used herein, sensor fusion may refer to combining sensor data or data derived from disparate sources such that the resulting information has less uncertainty than the information of the individual sources.

In an implementation form, the SFE encoding component may comprise a deep neural network, DNN, being configured to receive the sensor data at its input; infer a semantically processed feature vector from the received sensor data; and forward the inferred feature vector at its output.

As used herein, a deep neural network (DNN) may refer to an artificial neural network (ANN) with multiple hidden layers between the input and output layers.

In an implementation form, the JISC encoding component may comprise a sequence of alternating feature modules and attention modules. The respective feature module may comprise a DNN being configured to infer a semantically processed feature vector from a received feature vector; and output the inferred feature vector. The respective attention module may comprise a DNN being configured to infer a weight vector being indicative of a relevance of features of a received feature vector, in accordance with the channel model of the uplink channel of the wireless sensor network; and output a linear combination of the inferred weight vector and the received feature vector.

In an implementation form, the inferred weight vector may comprise a normalized vector.

As used herein, normalized may refer to a vector of unit length (i.e., unit vector).

In an implementation form, the JISC encoding component may further be configured to receive, from the sensor fusion device, channel-state information, CSI, defining the channel model of the uplink channel of the wireless sensor network.

As used herein, channel-state information (CSI) may refer to information being representative of current channel conditions, such as the combined knowledge of the known transmitted (i.e., training/pilot sequences) and the received signal in case of channel estimation.

In an implementation form, the SFE encoding component may further be configured to infer a semantically processed feature vector from the sensor data comprising labeled training data; send, to the sensor fusion device, the inferred feature vector; receive, from the sensor fusion device, an error vector at an output of the sensor device arrangement; and update weights of its DNN in accordance with the received error vector.

As used herein, labeled training data may refer to training data for supervised learning, including example input data and corresponding desired output data.

As used herein, supervised learning may refer to a fundamental machine learning technique for artificial neural networks, the goal being to learn a general rule that maps the example input data to the desired output data.

In an implementation form, the transceiver component may further be configured to record all forward operations being associated with the labeled training data; receive, from the sensor fusion device, an error vector at an output of the sensor device arrangement via a downlink channel of the wireless sensor network; and estimate an error vector at an output of the JISC encoding component in accordance with the received error vector and the recorded forward operations. The JISC encoding component may further be configured to update weights of its DNN in accordance with the estimated error vector.

As used herein, forward operations may refer to all the operations exercised by the respective transceiver component during inference, such as power normalization, quantization, signal modulation and the like. The idea is to be able to estimate an error (back)propagation in accordance with the recorded forward operations.

As used herein, a downlink channel may refer to a communication channel from the central entity of the wireless sensor network (i.e., the sensor fusion device) towards any one of the disparate sources of the wireless sensor network (i.e., the respective sensor device arrangement).

As used herein, an error vector may refer to a deviation of actual output data of an artificial neural network from its desired output data as specified by the labeled training data.

In an implementation form, the transceiver component may comprise one or more of: a power normalization unit, a quantization unit, and an orthogonal frequency-division multiplexing, OFDM, modulation unit.

According to a second aspect, a sensor fusion device is provided for distributed semantic processing of accumulated sensor data in a wireless sensor network. The sensor fusion device comprises a transceiver component and a joint inference-source-channel, JISC, decoding component. The transceiver component is configured to receive, from a plurality of sensor device arrangements, a respective channel-distorted JISC-encoded feature vector of a target variable via an uplink channel of the wireless sensor network. The JISC decoding component is configured to infer an estimate of the target variable from the received feature vectors in accordance with a channel model of the uplink channel of the wireless sensor network.

As used herein, joint inference-source-channel (JISC) decoding may refer to a combination of inference of the estimate of the target variable from the received feature vectors (being affected by the uplink channel), source decoding and channel decoding.

In an implementation form, the JISC decoding component may further be configured to receive channel-state information, CSI, defining the channel model of the uplink channel of the wireless sensor network.

In an implementation form, the sensor fusion device may further comprise an SFE decoding component being configured to receive, from the plurality of sensor device arrangements, a respective semantically processed feature vector of labeled training data; infer an estimate of the target variable from the received feature vectors; compute an error vector at an output of the SFE decoding component in accordance with the target variable and the inferred estimate of the target variable; and update weights of its DNN in accordance with the computed error vector; and send, to the respective sensor device arrangement, a respective error vector at an output of the respective sensor device arrangement.

As used herein, semantic feature extraction (SFE) decoding may refer to inference of the estimate of the target variable from the received feature vectors (not being affected by the uplink channel).

In an implementation form, the transceiver component may further be configured to record all forward operations being associated with the labeled training data. The JISC decoding component may further be configured to compute an error vector at an output of the JISC decoding component in accordance with the target variable and the inferred estimate of the target variable; and update weights of its DNN in accordance with the computed error vector. The transceiver component may further be configured to estimate a respective error vector at an output of the respective sensor device arrangement in accordance with the computed error vector, the recorded forward operations, and the channel model of the uplink channel; and transmit, to the respective sensor device arrangement, the respective error vector via a downlink channel of the wireless sensor network.

In an implementation form, the transceiver component may comprise an orthogonal frequency-division multiplexing, OFDM, demodulation unit.

According to a third aspect, a wireless sensor network is provided for distributed semantic processing of sensor data. The wireless sensor network comprises a plurality of sensor device arrangements of the first aspect or any of its implementations; and a sensor fusion device of the second aspect or any of its implementations, wherein the sensor fusion device and the respective sensor device arrangement are in wireless network communication.

According to a fourth aspect, a method is provided of operating a sensor device arrangement for distributed semantic processing of sensor data in a wireless sensor network. The method comprises generating the sensor data of a target variable, wherein the sensor data comprises one or more features; inferring a semantically processed feature vector from the sensor data; inferring a JISC-encoded feature vector from the inferred semantically processed feature vector in accordance with a channel model of an uplink channel of the wireless sensor network; and transmitting, to a sensor fusion device for distributed semantic processing of accumulated sensor data in the wireless sensor network, the inferred JISC-encoded feature vector via the uplink channel.

According to a fifth aspect, a method is provided of operating a sensor fusion device for distributed semantic processing of accumulated sensor data in a wireless sensor network. The method comprises receiving, from a plurality of sensor device arrangements, a respective channel-distorted JISC-encoded feature vector of a target variable via an uplink channel of the wireless sensor network; and inferring an estimate of the target variable from the received feature vectors in accordance with a channel model of the uplink channel of the wireless sensor network.

According to a sixth aspect, a computer program is provided, comprising a program code for performing the method of the fourth or fifth aspects or any of their implementations when executed on a computer.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a wireless sensor network 1, 2 in accordance with the present disclosure;

FIG. 2 illustrates the JISC encoding components 13 of FIG. 1 in more detail;

FIG. 3 illustrates the attention modules 132 of FIG. 2 in more detail;

FIG. 4 illustrates the transceivers 14, 24 of FIG. 1 in more detail;

FIGS. 5-7 illustrate a joint training of the SFE encoding components 12 and the SFE decoding component 22;

FIGS. 8-10 illustrate a joint training of the JISC encoding components 13 and the JISC decoding component 23; and

FIG. 11 illustrates interrelated flow charts of a method 3 of operating a sensor device arrangement 1 and a method 4 of operating a sensor fusion device 2, both in accordance with the present disclosure.

### DETAILED DESCRIPTIONS OF DRAWINGS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

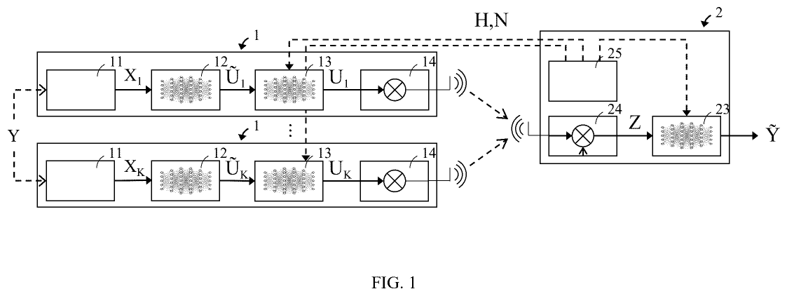

FIG. 1 illustrates a wireless sensor network 1, 2 in accordance with the present disclosure.

A multi-access network is considered with a plurality of sensor device arrangements 1 shown to the left of FIG. 1 being suitable for distributed semantic processing of sensor data Xₖ in the wireless sensor network 1, 2; and a sensor fusion device 2 shown to the right of FIG. 1 being suitable for distributed semantic processing of accumulated sensor data in the wireless sensor network 1,2.

The sensor fusion device 2 and the respective sensor device arrangement 1 are in wireless network communication.

Uplink communication from the respective sensor device arrangement 1 to the sensor fusion device 2 is done over a slow-fading wireless channel. We also consider (optionally) a low-bitrate feedback channel from the sensor fusion device 2 to the respective sensor device arrangement 1 used for communicating uplink channel parameters.

The respective sensor device arrangement 1 may acquire/sense partial data which are relevant for an inference task given to the sensor fusion device 2.

To this end, the respective sensor device arrangement 1 comprises a sensor component 11, a semantic feature extraction, SFE, encoding component 12, a joint inference-source-channel, JISC, encoding component 13, and a transceiver component 14.

The sensor component 11 is configured to generate the sensor data Xₖ of a target variable Y, wherein the sensor data Xₖ comprises one or more features Ũₖ.

The SFE component 12 is configured to infer a semantically processed feature vector Ũₖfrom the sensor data Xₖ.

More specifically, the SFE encoding component 12 may comprise a—trained—deep neural network (DNN) being configured to receive the sensor data Xₖ at its input; infer a semantically processed feature vector Ũₖfrom the received sensor data Xₖ; and forward the inferred feature vector Ũₖat its output.

In other words, the SFE component 12 takes as input available source data and outputs semantic features Ũₖwhich represent only these features of the source data which are relevant for the given inference task of the sensor fusion device 2. This plays the role of (i) compression (by removing redundant information) and (ii) de-noising (i.e., representing the relevant features in a form that is better adapted for further processing). The semantic features Ũₖ are complementary to the features extracted by other sensor device arrangement 1 (this is done without explicit coordination between the sensor device arrangements 1 by suitably training the DNNs such that they know at the statistical level what is the useful information available at other sensor device arrangement 1).

Note that the SFE encoding component 12 is an application layer functionality and does not take into account the communication channel.

By contrast, the JISC encoding component 13 is a physical layer functionality which does take into account the communication channel.

As such, the JISC decoding component 23 may further be configured to receive channel-state information (CSI) H, N defining the channel model of the uplink channel of the wireless sensor network 1, 2.

And this is why the JISC encoding component 13 is configured to infer a JISC-encoded feature vector Uₖ from the inferred semantically processed feature vector Ũₖin accordance with the channel model of the uplink channel of the wireless sensor network 1, 2.

The (optional) uplink channel parameters communicated by the sensor fusion device 2 through the feedback channel are useful when the characteristics of the wireless channel change over time (e.g., due to degraded signal-to-noise-ratio). With these parameters, each JISC encoding component 13 may better encode semantic features Uₖ by taking into account the quality of its own channel, but also of the channels of other sensor device arrangements 1.

In more detail, the JISC encoding component 13 takes as input semantic features Ũₖ from the SFE encoding component 12 and (possibly) uplink channel parameters, and outputs JISC encodings Uₖ which may further compress the input semantic features to match the channel capacity, are adapted to transmission over the wireless channel by (i) protecting the most relevant semantic features (to make them robust against channel distortions) and (ii) adapting to the characteristics of the wireless channel (e.g., channel noise, multi-path propagation, interference, etc.), and are complementary to the JISC encodings of other sensor device arrangements 1 (similarly as in SFE, this is done without explicit coordination between the devices; by suitably training the DNNs such that they know which sensor device arrangement 1 is good at what and which sensor device arrangement 1 has a good/bad communication channel).

Note that JISC encodings Uₖ could be correlated across the sensor device arrangements 1. This may happen when the JISC encoders learn implicitly to cooperate by exploiting positive superposition and interference of wireless signals generated by other sensor device arrangements 1.

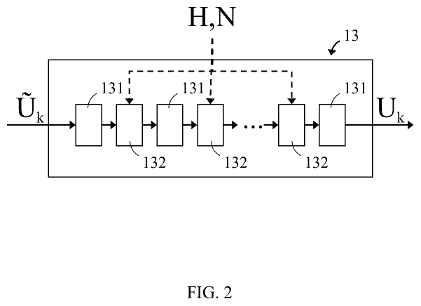

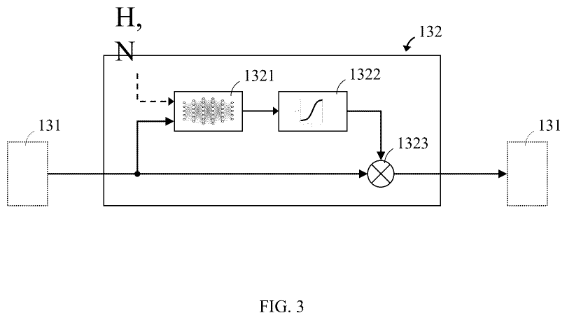

A design/setup of the JISC encoding component 13 will be explained in more detail in connection with FIGS. 2, 3 below.

The transceiver component 14 is configured to transmit, to a sensor fusion device 2 for distributed semantic processing of accumulated sensor data in the wireless sensor network, the inferred JISC-encoded feature vector Uₖ via the uplink channel.

Note that no particular method of encoding and modulating the JISC encodings Uₖ onto a physical signal, of signal transmission over the wireless channel, and of signal reception and demodulation at the sensor fusion device 2 is assumed.

The separation of the SFE encoding component 12 and the JISC encoding component 13 has several advantages:

First, it offers the required modularity, because the SFE encoding component 12 and the JISC encoding component 13 are implemented at two different functional layers, and they can be provided by two different entities (e.g., SFE encoding component 12 by the application provider and the JISC encoding component 13 by the network provider). Each of the components 12, 13 could also be replaced without the significant loss of the system's performance, provided that the input/output distributions of the components 12, 13 remain similar as before.

Second, it offers improved flexibility, because the JISC encoding component 13 could easily be retrained to new source distributions and channel distributions (e.g., when the sensor component 11 (e.g. camera) of the SFE encoding component 12 is moved from indoor to outdoor environments, or when one of the sensor device arrangements 1 is missing). Furthermore, since the output of the SFE encoding component 12 is already de-noised, the retraining of the JISC encoding component 13 would require massively less communication and computation resources than full training from scratch.

The sensor fusion device 2 comprises a transceiver component 24 and a joint inference-source-channel, JISC, decoding component 23, and may further comprise a channel estimation component 25.

The transceiver component 24 is configured to receive, from a plurality of sensor device arrangements 1, a respective channel-distorted JISC-encoded feature vector Z of a target variable Y via an uplink channel of the wireless sensor network.

The JISC decoding component 23 is configured to infer an estimate \tilde{Y} of the target variable Y from the received feature vectors Z (possibly distorted by the channel) in accordance with a channel model of the uplink channel of the wireless sensor network.

Note that there is no explicit reconstruction of transmitted JISC encodings before feeding to the JISC decoding component 23. This is in contrast to conventional joint source-channel coding (JSCC) frameworks.

The channel estimation component 25 may be configured to estimate the channel model of the uplink channel of the wireless sensor network 1, 2 and to provide corresponding CSI H, N to the respective sensor device arrangement 1 as well as to the JISC decoding component 23.

FIG. 2 illustrates the JISC encoding components 13 of FIG. 1 in more detail.

As just mentioned, uplink channel parameters may be communicated to the respective sensor device arrangement 1. This feedback information may help the JISC encoding components 13 to better adapt to fluctuating channel conditions. However, it is not immediately obvious how this additional information can be used. A possible design/setup may be based on so-called attention modules.

In more detail, the JISC encoding component 13 (and likewise the JISC decoding component 23) may comprise a sequence of alternating feature modules 131 and attention modules 132.

In accordance with what has been said before, the JISC encoding component 13 may further be configured to receive, from the sensor fusion device 2, CSI H, N defining the channel model of the uplink channel of the wireless sensor network 1, 2.

The respective feature module 131 may comprise a DNN, in particular a conventional fully-connected DNN, being configured to infer a semantically processed feature vector Ũₖ from a received feature vector Ũₖ; and output the inferred feature vector Ũₖ.

By contrast, the respective attention module 132 makes use of the CSI H, N defining the channel model.

FIG. 3 illustrates the attention modules 132 of FIG. 2 in more detail.

The respective attention module 132 may comprise a DNN 1321, a softmax component 1322 and a linear combination component 1323.

The DNN 1321 (in particular a conventional fully-connected DNN) and the softmax component 1322 are collectively configured to infer a weight vector wᵢ being indicative of a relevance of features of a received feature vector Ũₖ, in accordance with the channel model (as represented by the CSI H, N) of the uplink channel of the wireless sensor network 1, 2.

The vector of attention weights wᵢ describes the relevance of each feature. For example, a vector of attention weights wᵢ may comprise numbers between 0 and 1, where values close to 1 describe relevant features and values close to 0 describe irrelevant features.

In particular, the inferred weight vector wᵢ may comprise a normalized vector.

The linear combination component 1323 is configured to perform a linear combination of the inferred weight vector wᵢ and the received feature vector Ũₖ in order to obtain a new attention-weighted feature vector.

The role of the attention modules 132 is to control a level of protection of the most relevant information. For example, if the channel conditions are good, the attention modules 132 tend to allow transmission of all features. On the contrary, when the channel introduces severe distortions, the attention modules 132 suppress less relevant information to allow better protection of core features. Thereby, a flexible adaptation to fluctuating channel conditions may be achieved.

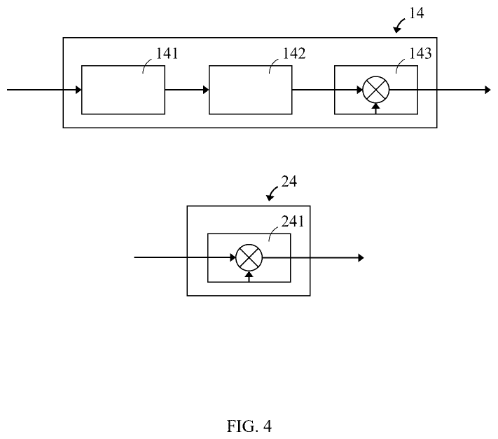

FIG. 4 illustrates the transceivers 14, 24 of FIG. 1 in more detail.

Although no particular modulation and demodulation techniques are assumed, it is nevertheless possible to specify the transceivers 12, 24 in accordance with a particular physical-layer implementation such as orthogonal frequency-division multiplexing (OFDM).

On the side of the sensor device arrangements 1, each JISC encoding component 13 may be trained to map SFE encodings Ũₖ directly into a sequence of OFDM symbols expressed as complex values in an in-phase/quadrature (I/Q) domain. Additionally, the transceiver component 14 may comprise one or more of: a power normalization unit 141, a quantization unit 142, and an OFDM modulation unit 143.

Therefore, the output OFDM symbols can be normalized in order to keep the maximum signal power within some predefined limits, and/or the OFDM symbols could be quantized if some fixed symbol constellation is used (e.g., QAM). Produced OFDM symbols may be transformed into baseband waveforms, modulated to a high-frequency sub-carrier, and transmitted over a shared multi-access narrow-band channel. Signal modulation can be done using the conventional IFFT-based modulation technique, a cyclic prefix (CP) could be added in order to reduce inter-symbol interference (ISI), and the sensor device arrangements 1 may transmit simultaneously on a same sub-carrier in a synchronous manner. In such cases, the transmitted OFDM signals will superimpose and form a new combined OFDM signal.

On the side of the sensor fusion device 2, the transceiver component 24 may comprise an OFDM demodulation unit 241 being configured to demodulate channel-distorted OFDM symbols Z.

As such, signal demodulation can be done using the conventional FFT-based demodulation technique, and the recovered channel-distorted OFDM symbols Z may be fed directly to the JISC decoding component 23 in order to infer the estimate \tilde{Y} of the target variable Y.

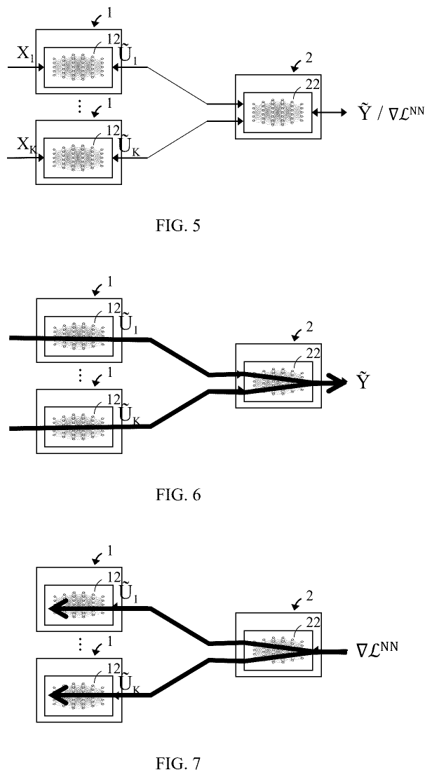

FIGS. 5-7 illustrate a joint training of the SFE encoding components 12 and the SFE decoding component 22.

This first training procedure does not depend on the wireless channel and can thus be performed fully at the application layer in connection with a joint SFE decoding component 22.

In short, the SFE encoding components 12 are trained to infer/extract only those semantic features Ũₖ of the labeled training data which are relevant for the given task, and which are complementary to those inferred at other sensor device arrangements 1.

During a forward pass (see FIG. 6), the SFE encoding components 12 perform inference as already mentioned, based on sensor data Xₖ comprising labeled training data.

In other words, the SFE encoding component 12 may be configured to infer a semantically processed feature vector Ũₖ from the sensor data Xₖ comprising labeled training data; and send, to the sensor fusion device 2, the inferred feature vector Ũₖ.

Note that especially for training, the sensor fusion device 2 may further comprise an SFE decoding component 22, being configured to receive, from the plurality of sensor device arrangements 1, a respective semantically processed feature vector Ũₖ of labeled training data; infer an estimate \tilde{Y} of the target variable Y from the received feature vectors Ũₖ; compute an error vector ∇ [symbol] ^{NN} at an output of the SFE decoding component 22 in accordance with the target variable Y and the inferred estimate \tilde{Y} of the target variable Y; and update weights of its DNN in accordance with the computed error vector ∇ [symbol] ^{NN}.

During a backward pass (see FIG. 7), the SFE decoding component 22 may further be configured to send, to the respective sensor device arrangement 1, a respective error vector at an output of the respective sensor device arrangement 1.

The SFE encoding component 12 may further be configured to receive, from the sensor fusion device 2, the error vector at the output of the sensor device arrangement 1; and update weights of its DNN in accordance with the received error vector.

At the end of this first training procedure, the joint SFE decoding component 22 is discarded and the weights of the DNNs of the SFE encoding components 12 are frozen (they are not updated anymore).

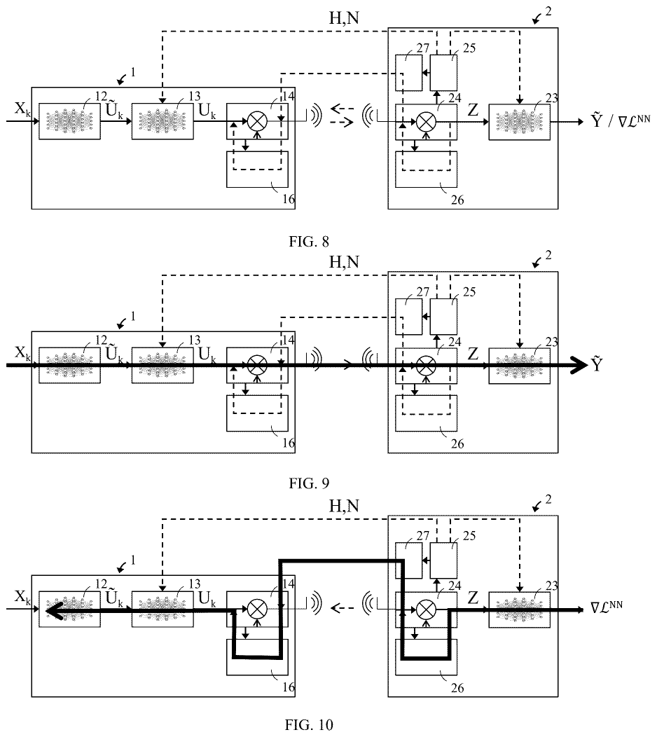

FIGS. 8-10 illustrate a joint training of the JISC encoding components 13 and the JISC decoding component 23; and

In short, the JISC encoding components 13 are trained to produce JISC encodings Uk adapted to transmission over the wireless channel, and the JISC decoding component 23 is trained to infer the target variable from distorted data.

This second training procedure does depend on the wireless channel, either real or simulated.

During a forward pass (see FIG. 9), the respective sensor device arrangement 1 and the sensor fusion device 2 perform inference as already mentioned. Note, however, that the inference by the SFE encoding component 12 of the respective sensor device arrangement 1 is based on sensor data Xₖ comprising labeled training data and on the frozen weights of the first training step.

That is to say, the training samples are propagated through the frozen SFE encoding component 12, the JISC encoding component 13, and the transceiver component 14. Next, the produced signals are simultaneously transmitted via the uplink channel, and received at the sensor fusion device 2, where the transceiver component 24 demodulates the signal and feeds the retrieved data to the JISC decoding component 23 in order to infer the target variable.

In order to enable suitable update of the involved DNNs, all forward operations are recorded and kept in memory of respective devices 1, 2. In addition to this, the sensor fusion device 2 may estimate the parameters of the wireless channel and (optionally) communicate them to all sensor device arrangement 1. For example, this may be based on the additional recording/estimation components 16, 26, 27 shown in FIGS. 8-10 .

During a backward pass (see FIG. 10), the JISC decoding component 23 may further be configured to compute an error vector (the value of the loss function) at an output of the JISC decoding component 23 in accordance with the target variable Y and the inferred estimate \tilde{Y} of the target variable Y; and update weights of its DNN in accordance with the computed error vector.

The transceiver component 24 may further be configured to estimate a respective error vector at an output of the respective sensor device arrangement 1 (note the dashed arrows passing through the recording/estimation components 26, 27 in FIG. 8) in accordance with the computed error vector, the recorded forward operations, and the channel model of the uplink channel; and transmit, to the respective sensor device arrangement 1, the respective error vector via a downlink channel of the wireless sensor network.

The transceiver component 14 may further be configured to receive, from the sensor fusion device 2, an error vector at an output of the sensor device arrangement 1 via the downlink channel of the wireless sensor network; and estimate an error vector at an output of the JISC encoding component 13 (note the dashed arrow passing through the recording/estimation component 16 in FIG. 8) in accordance with the received error vector and the recorded forward operations.

The JISC encoding component 13 may further be configured to update weights of its DNN in accordance with the estimated error vector.

The above second training procedure is repeated until convergence. In order to improve robustness of the system to fluctuating channel conditions, the involved DNNs should be preferably trained under varying channel parameters.

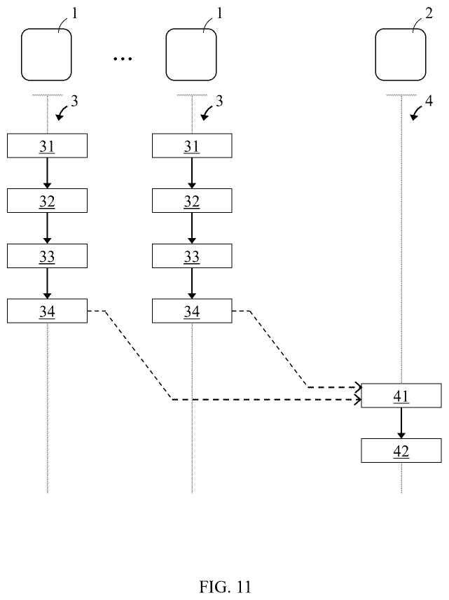

FIG. 11 illustrates interrelated flow charts of a method 3 of operating a sensor device arrangement 1 and a method 4 of operating a sensor fusion device 2, both in accordance with the present disclosure.

The illustrative example depicts a wireless sensor network 1, 2 for distributed semantic processing of sensor data.

The wireless sensor network 1, 2 comprises a plurality of (here two) sensor device arrangements 1 and a sensor fusion device 2.

The respective sensor device arrangement 1 is configured to perform the method 3 of operating the sensor device arrangement 1.

The method 3 comprises a step of generating 31 the sensor data Xₖ of a target variable Y, wherein the sensor data Xₖ comprises one or more features Ũₖ.

The method 3 further comprises a step of inferring 32 a semantically processed feature vector Ũₖ from the sensor data Xₖ.

The method 3 further comprises a step of inferring 33 a JISC-encoded feature vector Uₖ from the inferred semantically processed feature vector Ũₖ in accordance with a channel model of an uplink channel of the wireless sensor network.

The method 3 further comprises a step of transmitting 34, to a sensor fusion device 2 for distributed semantic processing of accumulated sensor data in the wireless sensor network, the inferred JISC-encoded feature vector Uₖ via the uplink channel.

The sensor fusion device 2 is configured to perform the method 4 of operating the sensor fusion device 2.

The method 4 comprises a step of receiving 41, from a plurality of sensor device arrangements 1, a respective channel-distorted JISC-encoded feature vector Z of a target variable Y via an uplink channel of the wireless sensor network.

The method 4 further comprises a step of inferring 42 an estimate \tilde{Y} of the target variable Y from the received feature vectors Z in accordance with a channel model of the uplink channel of the wireless sensor network.

To sum up, a wireless sensor network 1, 2 is proposed for distributed joint inference-source-channel coding in a multi-access network of devices comprised of one or more sensor device arrangements 1 (“edge device”) and a sensor fusion device 2 (“parent device”), and providing the following:

Distributed (joint) Semantic Feature Extraction (SFE)
a. at the application layer of each edge device,
b. takes as input source input data and outputs semantic features,
c. aims at extracting only those features that are relevant for a given task,
d. takes into account complementarity of information across the edge devices (without explicit coordination).

Joint Inference-Source-Channel (JISC) encoding
a. at the Physical Layer of each edge device,
b. takes as input semantic features from respective SFE and (possibly) uplink channel parameters, and outputs JISC encodings,
c. jointly accounts for the degree of inference/relevance for the given task (distributed inference), the locally observed data sample and implicitly those samples observed by the other devices (distributed source coding), and adaptation to the channel (channel coding).

Joint Inference-Source-Channel (JISC) decoding
a. takes as input received JISC encodings (possibly distorted by the channel) and (possibly) uplink channel parameters, and outputs an estimate of the target variable.

The present disclosure has been described in conjunction with various implementations as examples. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A sensor device arrangement for distributed semantic processing of sensor data (Xₖ) in a wireless sensor network, the sensor device arrangement comprising
a sensor component, being configured to
generate the sensor data (Xₖ) of a target variable (Y), the sensor data (Xₖ) comprising one or more features (Ũₖ);
a semantic feature extraction (SFE) encoding component, being configured to
infer a semantically processed feature vector (Ũₖ) from the sensor data (Xₖ);
a joint inference-source-channel (JISC) encoding component, being configured to
infer a JISC-encoded feature vector (Uₖ) from the inferred semantically processed feature vector (Ũₖ) in accordance with a channel model of an uplink channel of the wireless sensor network; and
a transceiver component, being configured to
transmit, to a sensor fusion device for distributed semantic processing of accumulated sensor data in the wireless sensor network, the inferred JISC-encoded feature vector (Uₖ) via the uplink channel.

2. The sensor device arrangement of claim 1,
the SFE encoding component comprising a deep neural network (DNN), being configured to
receive the sensor data (Xₖ) at its input;
infer a semantically processed feature vector (Ũₖ) from the received sensor data (Xₖ); and
forward the inferred feature vector (Ũₖ) at its output.

3. The sensor device arrangement of claim 1,
the JISC encoding component comprising a sequence of alternating feature modules and attention modules;
the respective feature module comprising a DNN being configured to
infer a semantically processed feature vector (C) from a received feature vector (Ũₖ); and
output the inferred feature vector (Ũₖ);
the respective attention module comprising a DNN being configured to
infer a weight vector (wᵢ) being indicative of a relevance of features of a received feature vector (Ũₖ), in accordance with the channel model of the uplink channel of the wireless sensor network; and
output a linear combination of the inferred weight vector (wᵢ) and the received feature vector (Ũₖ).

4. The sensor device arrangement of claim 3,
the inferred weight vector (wᵢ) comprising a normalized vector.

5. The sensor device arrangement of claim 1,
the JISC encoding component further being configured to
receive, from the sensor fusion device, channel-state information (CSI), defining the channel model of the uplink channel of the wireless sensor network.

6. The sensor device arrangement of claim 1,
the SFE encoding component further being configured to
infer a semantically processed feature vector (Ũₖ) from the sensor data (Xₖ) comprising labeled training data;
send, to the sensor fusion device, the inferred feature vector (Ũₖ);
receive, from the sensor fusion device, an error vector at an output of the sensor device arrangement; and
update weights of its DNN in accordance with the received error vector.

7. The sensor device arrangement of claim 6,
the transceiver component further being configured to
record all forward operations being associated with the labeled training data;
receive, from the sensor fusion device, an error vector at an output of the sensor device arrangement via a downlink channel of the wireless sensor network; and
estimate an error vector at an output of the JISC encoding component in accordance with the received error vector and the recorded forward operations; and
the JISC encoding component further being configured to
update weights of its DNN in accordance with the estimated error vector.

8. The sensor device arrangement of claim 1,
the transceiver component comprising one or more of:
a power normalization unit,
a quantization unit, and
an orthogonal frequency-division multiplexing (OFDM) modulation unit.

9. A sensor fusion device for distributed semantic processing of accumulated sensor data in a wireless sensor network, the sensor fusion device comprising
a transceiver component, configured to
receive, from a plurality of sensor device arrangements, a respective channel-distorted joint inference-source-channel (JISC)-encoded feature vector (Z) of a target variable (Y) via an uplink channel of the wireless sensor network; and
a JISC decoding component, configured to
infer an estimate (\tilde{Y}) of the target variable (Y) from the received feature vectors (Z) in accordance with a channel model of the uplink channel of the wireless sensor network.

10. The sensor fusion device of claim 9,
the JISC decoding component further being configured to
receive channel-state information (CSI), defining the channel model of the uplink channel of the wireless sensor network.

11. The sensor fusion device of claim 9,
the sensor fusion device further comprising an SFE decoding component being configured to
receive, from the plurality of sensor device arrangements, a respective semantically processed feature vector (Ũₖ) of labeled training data;
infer an estimate (\tilde{Y}) of the target variable (Y) from the received feature vectors (Ũₖ);
compute an error vector (∇ [symbol] ^{NN}) at an output of the SFE decoding component in accordance with the target variable (Y) and the inferred estimate (\tilde{Y}) of the target variable (Y);
update weights of its deep neural network (DNN) in accordance with the computed error vector (∇ [symbol] ^{NN}); and
send, to the respective sensor device arrangement, a respective error vector at an output of the respective sensor device arrangement.

12. The sensor fusion device of claim 9,
the transceiver component further being configured to
record all forward operations being associated with the labeled training data;
the JISC decoding component further being configured to
compute an error vector at an output of the JISC decoding component in accordance with the target variable (Y) and the inferred estimate (\tilde{Y}) of the target variable (Y); and
update weights of its DNN in accordance with the computed error vector;
the transceiver component further being configured to
estimate a respective error vector at an output of the respective sensor device arrangement in accordance with the computed error vector, the recorded forward operations, and the channel model of the uplink channel; and
transmit, to the respective sensor device arrangement, the respective error vector via a downlink channel of the wireless sensor network.

13. The sensor fusion device of claim 9,
the transceiver component comprising an orthogonal frequency-division multiplexing (OFDM) demodulation unit.

14. A method of operating a sensor device arrangement for distributed semantic processing of sensor data (Xₖ) in a wireless sensor network, the method comprising
generating the sensor data (Xₖ) of a target variable (Y), the sensor data (Xₖ) comprising one or more features (Ũₖ);
inferring a semantically processed feature vector (Ũₖ) from the sensor data (Xₖ);
inferring a joint inference-source-channel (JISC)-encoded feature vector (Uₖ) from the inferred semantically processed feature vector (Ũₖ) in accordance with a channel model of an uplink channel of the wireless sensor network; and
transmitting, to a sensor fusion device for distributed semantic processing of accumulated sensor data in the wireless sensor network, the inferred JISC-encoded feature vector (Uₖ) via the uplink channel.
